(19) United States
(12) Patent Application Publication
(10) Pub. No.: US 2006/0180476 A1
(43) Pub. Date: Aug. 17, 2006

(54) Apparatus and method for disposing of solid waste through electrochemical reactions

(75) Inventor: Burnard P. Bockris, Gainesville, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: World Hydrogen, Inc., Gainesville, FL (US)

(21) Appl. No.: 11/057,910

(22) Filed: Feb. 15, 2005

(51) Int. Cl. C02F 1/461; B01J 19/08

(52) U.S. Cl. 205/756; 422/186.04

(57) ABSTRACT

An apparatus for converting solid waste. The apparatus includes a container at least partially filled with a solution. A cathode and an anode are disposed in the container and at least partially submerged in the solution. The container further includes an oxygen supply and an opening in the container for receiving waste material into the solution near the anode. The anode and cathode are electrically coupled by an electrically conductive path. Oxygen molecules are reduced at the cathode whereby electrons are added to the oxygen molecules in the solution so that, together with H⁺ ions, water is formed. Electrons take part in the dissociation of the waste material in the solution and are accepted at the anode. In addition, chemical reactions on the electrode surface occur. The electrons then move to the cathode through the electrically conductive path, producing an electric current between the anode and cathode.

### FIELD OF THE INVENTION

The present invention relates generally to waste, and more particularly relates to disposing of solid waste through electrochemical reactions.

### BACKGROUND OF THE INVENTION

It is well known that the United States, as well as many other countries, has a mounting problem with the disposal of sewage and other wastes. Examples of waste are: municipal, industrial, medical, garden and farm, and sewage.

Until the 1980's, most wastes were disposed of by incineration. Tall chimneys emitted smoke from the burned waste into the atmosphere. The smoke contained some solids and a mixture of gases. The particles gradually fell to earth up to 25 miles away from the chimney. The gaseous product, primarily CO₂ and NO₂, added to environmental pollution.

Laws and regulations were ultimately created to prevent the spread of a community's pollution on itself and the surrounding areas. The alternative has been to create “landfills,” in which waste is compressed and piled on top of other waste and then filled over with dirt.

Landfills suffer from the disadvantages of taking large amounts of valuable land, having a maximum storage limit on each particular piece of land, emitting foul smells into the surrounding areas, allowing dangerous chemical seepage to enter water aquifers below or in the proximity of the landfill, and other similar problems.

Some alternative processes of dealing with wastes involve chemical treatments. However, all currently available methods of chemically treating waste are incomplete in the sense that they end up with a final solid product. At present, the portion of the waste that cannot be recycled is spread over land or confined to landfills. However, rain dissolves chemicals out of these wastes and, over a long period of time, carries toxic components to the watershed, or to aquifers, so as to contaminate what had essentially been a pure water source.

Experiments have been performed to find methods of dealing with human waste which involve the use of electricity. For example, during investigations pertinent to lengthy journeys in space, NASA sought a way to convert human waste to useful products. One such method proposed was to use an electrochemical cell. Such a cell involves a chamber containing two electrodes—an anode and a cathode. The electrodes are electrically driven by an applied power source. The cell converts the waste to CO₂ and nitrogen at the anode and hydrogen at the cathode.

However, the cell requires electricity to drive it. The need for electricity is disadvantageous in that it comes at a price, and in some circumstances is a scarce commodity.

One known generator of electricity is a fuel cell. An electricity-generating fuel cell is distinguished from the driven cell, as described above. An electricity-generating fuel cell does not require application of an outside potential, but instead generates its own voltage between two electrodes.

Almost all fuel cells require two fuels, with one nearly always being oxygen (O₂) from air. In the process of creating energy, one electrode, the “cathode,” gives electrons to the oxygen, which is then reduced with the help of H⁺ ions in the solution to water (H₂O). In other words, the O₂ molecule separates and each O atom joins two H⁺ ions. However, these electrons have to come from somewhere, and they come from the fuel, which reacts at the anode to inject electrons into the fuel cell circuit.

The best fuel to fuel a fuel cell is hydrogen. The H₂ molecule gives electrons up to the other electrode, the “anode” and these electrons travel through the circuit and ultimately reduce O₂ to water. In the process, the traveling electrons give part of their energy to a load (e.g., an electric motor) located in a conductive path between the electrodes, and thus do work.

However, the need for the supply of fuel for the fuel cell brings with it the disadvantages of cost, location of resources, storage, and others.

Therefore a need exists to overcome the problems with the prior art as discussed above.

### SUMMARY OF THE INVENTION

Briefly, in accordance with one embodiment of the present invention, disclosed is a apparatus and method for converting waste to gaseous byproducts while, simultaneously, producing electricity. The apparatus includes a container at least partially filled with a solution. A cathode and an anode are disposed in the container and at least partially submerged in the solution. The container further includes an oxygen supply and an opening in the container for receiving waste material into the solution near the anode. The anode and cathode are electrically coupled by an electrically conductive path. Oxygen molecules are reduced at the cathode which receives electrons around the circuit from the anode. The waste material in the solution reacts at the anode to give electrons, thereby undergoing oxidation, destruction, and conversion to CO₂, N₂, etc. The electrons then move to the cathode through the electrically conductive path, producing an electric current.

In one preferred embodiment of the present invention, a resistive load is disposed along the conductive path between the cathode and the anode. The current produced by the device drives the resistive load.

In another embodiment of the present invention, the container is divided into a first chamber that includes the cathode, and a second chamber that includes the anode and is in liquid communication with the first chamber.

Another embodiment of the present invention provides a method for disposing of waste. According to the method, waste material is added to a chamber that includes either a highly acidic or a highly alkaline solution, a cathode that includes platinum, and an anode that includes ruthenium oxide, the cathode and anode being electrically coupled. The method further includes supplying oxygen so that oxygen molecules are reduced at the cathode. The electron transfer is part of a series of steps which disassociate the waste material in the solution at the anode, and then move to the cathode through the electrically conductive path so as to produce an electric current.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is block diagram illustrating one embodiment of a waste conversion apparatus in accordance with the present invention.

FIG. 2 is a diagram illustrating one embodiment of a cathode in accordance with the present invention.

FIG. 3 is a diagram illustrating one embodiment of cathode pore in accordance with the present invention.

FIG. 4 is a graph charting the cathode and anode electric potentials vs. the log current density within the cathode and anode in accordance with the present invention.

FIG. 5 is a flow diagram of the waste conversion process in accordance with a preferred embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to one embodiment, overcomes problems with the prior art by converting solid waste into gaseous byproducts while simultaneously generating electricity. The amount of solid waste that must be placed in landfills and the chemicals that are available to seep into the earth and aquifers are thereby reduced or eliminated. In addition, the byproducts of the conversion are useful for a variety of applications. Furthermore, the conversion of the waste works to generate electricity.

The present invention provides an electrochemical energy conversion apparatus, often referred to as a “fuel cell.” A fuel cell converts chemicals into electricity, so as to produce a DC voltage that can be used when put in series with several other cells to power motors, lights, or any other electrical device. The efficiency of conversion of chemicals to electricity in hydrogen-oxygen fuel cells is about 50 to 60 percent, which is nearly double the efficiency of a typical heat engine, such as is used in an automobile, which operates with an efficiency of around 30 percent.

The fuel cell of the preferred embodiment of the present invention includes two connected chambers, the first for holding solution and the second for holding solution and dissolved waste material. One chamber contains an anode and the other chamber contains a cathode. The term “cathode” represents an electrode that gives out electrons to chemicals in solution. The term “anode” represents an electrode that accepts electrons from materials in the solution. In the first chamber an oxygen cathode is operative and oxygen undergoes a reduction process by forming water. In the other chamber, the wastes are oxidized at an anode that contains catalyst material.

The oxygen is supplied by an air supply coupled to the first chamber. Ultimately, products of the oxidation of the wastes, e.g., CO₂, are removed and sequestered from the second chamber.

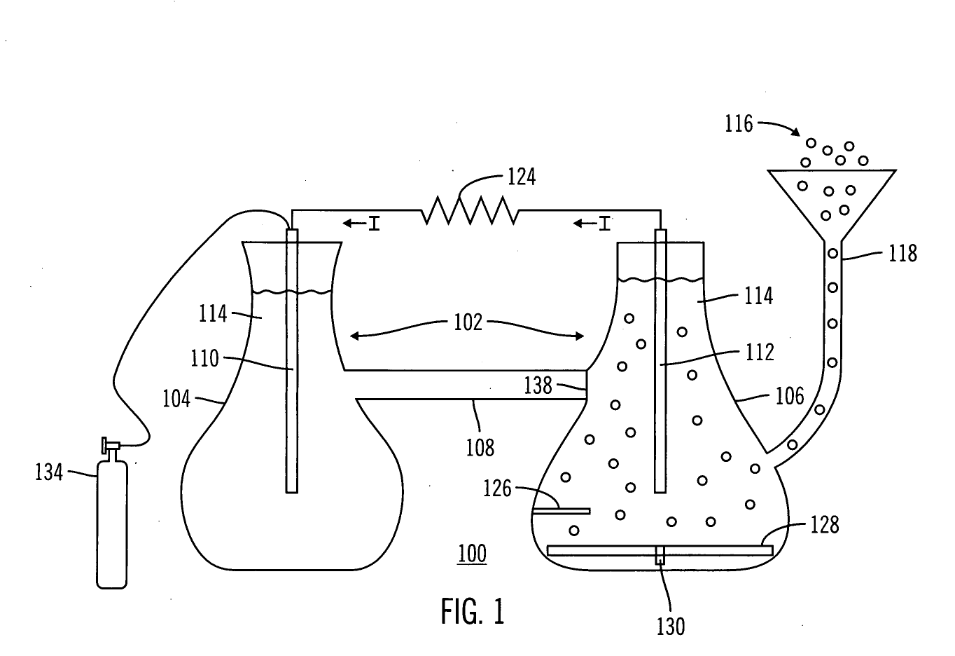

Described now in detail is an exemplary physical structure according to one embodiment of the present invention. Referring to FIG. 1, an apparatus 100 for breaking down waste material, according to this exemplary embodiment, is shown. The apparatus 100 includes a container 102 that includes a first chamber 104 and a second chamber 106. Each chamber 104 and 106 is an at least partially closed vessel for containing solution and materials and in this embodiment is bulbous, but in further embodiments can be any shape that will hold the solution and materials. In other embodiments, the container 102 is a single chamber that includes the elements shown in FIG. 1 to be within the two chambers 104 and 106. Other embodiments of the waste-converting chamber are possible without departing from the spirit and scope of the present invention.

The chambers 104 and 106 are connected by a connecting tube 108. In this embodiment, inside the connecting tube 108 and separating the two chambers 104 and 106 is a proton-conducting membrane 138. The membrane 138 prevents waste particles 116 from entering the first chamber 104. However, a connecting tube 108 is not necessary and any opening or arrangement that provides fluid communication between the chambers 104 and 106 is within the spirit and scope of the present invention. For instance, in one embodiment, the two chambers 104 and 106 are directly adjacent each other and separated by a single wall with an opening.

Each chamber 104 and 106 contains a quantity of solution 114, into which the cathode 110 and anode 112 are at least partially submerged. In one embodiment, the solution 114 is H₂SO₄. In another embodiment of the present invention, the solution 114 is very concentrated (e.g., about 98 percent) H₃PO₄. The purpose of the very concentrated H₃PO₄ solution is that it contains very little water (e.g., about 2 percent) and enables the system to be heated to temperatures of about 150° C., which greatly improves the electrocatalysis.

More generally, the solution 114 can be any solution that is a concentrated acid solution, with either 1-10 molar H₂SO₄ or 98 percent H₃PO₄ being the preferred acids. In the former, the temperatures should remain below about 95°, and in the later, the temperatures may be increased to about 140°.

In the illustrated embodiment of the present invention, a heating element 126 is provided within one or both chambers for heating the solution 114, and ultimately the waste material 116. The heating element 126 is a resistive heat element or any other heating device capable of bringing the solution temperature within a desired range. In other embodiments, the heating element is outside the container 106 and heats the solution 114 by applying heat to a surface of one or more of the chambers 104 and 106. The heating element(s) is provided so that the temperature of the containers is at the appropriate chosen range, such as between about 90° and about 150° C. depending on the acidic solution 114 present.

The waste material 116 can be organic waste, garden waste, industrial waste, sewage, or a combination thereof. In one preferred embodiment of the present invention, the waste material 116 is subjected to one or more processes aimed at reducing the particle sizes prior to introduction into the second chamber 106. Methods of reducing particle size are known. For instance, the wastes 116 can be subjected to chopping in a guillotine-type device. The wastes 116 can further be treated in a homogenizer. In still further embodiments, the material 116 can be placed in a mill and ground down further.

Once the waste material 116 is reduced to particle sizes of about 0.1 mm or less, the material 116 can be subject to ultrasound, that exposes the material 116 is exposed to intense vibrations, which break apart or separate the material, and produce smaller particle sizes on the order of about 1 μm or less. Other processes, such as crushing, tearing, bending, grinding, compressing, and the like, can be used as well. In other embodiments of the present invention, the waste materials are dissolved in acid to molecular size, but in the absence of sufficient solubility, it is a goal of the process of this embodiment that the wastes are subject to a great reduction in particle size.

The chopped-up, powder-like material 116 is then injected into the second chamber 106. Any technique and method that introduces the waste material 116 into the chamber 106, and ultimately into the solution 114, can be used without departing from the spirit and scope of the present invention.

As will now be explained in detail, the electrodes 110 and 112, along with the solution 114 and waste material 116, create a circuit that results in a fuel cell that produces a net gain of electrical energy while breaking down waste molecules.

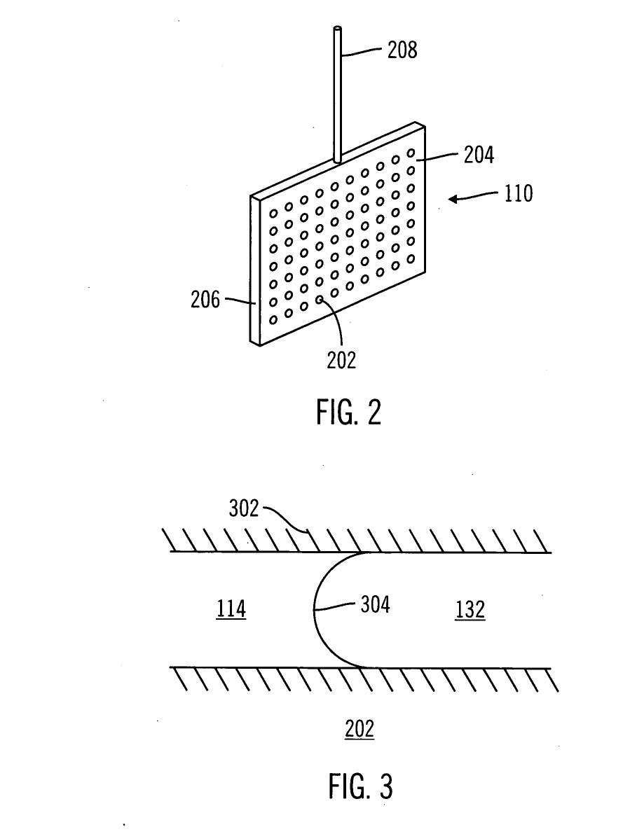

Referring now to FIG. 2, the cathode 110 of one embodiment is shown in more detail. In one embodiment, the cathode 110 is a porous structure, e.g., of graphite. In the pores 202 is deposited highly divided platinum material, which acts as a catalyst from which a charge transfer occurs. The use of porous electrodes is known in the art to significantly increase currents over planar electrodes. A description of porous electrodes and their advantages can be found in J. O'M. Bockris and Amuaya Reddy, Modern Electrochemistry, 2^{nd} Ed., vol. 2B, which is herein incorporated by reference in its entirety.

The pores 202 penetrate from an outside surface 204 of the cathode 110 to an inside area 206. Air, which naturally contains oxygen (O₂), is pumped into the inside area 206 of the cathode 110 where it seeps into the pores 202. The air can be pumped down a hollow lead-line 208 or another air passageway.

An exemplary air supply 134 is shown in FIG. 1. In this embodiment, the air comes from a pressurized container 134. In further embodiments, the air comes from any continuous or non-continuous air-producing device or process.

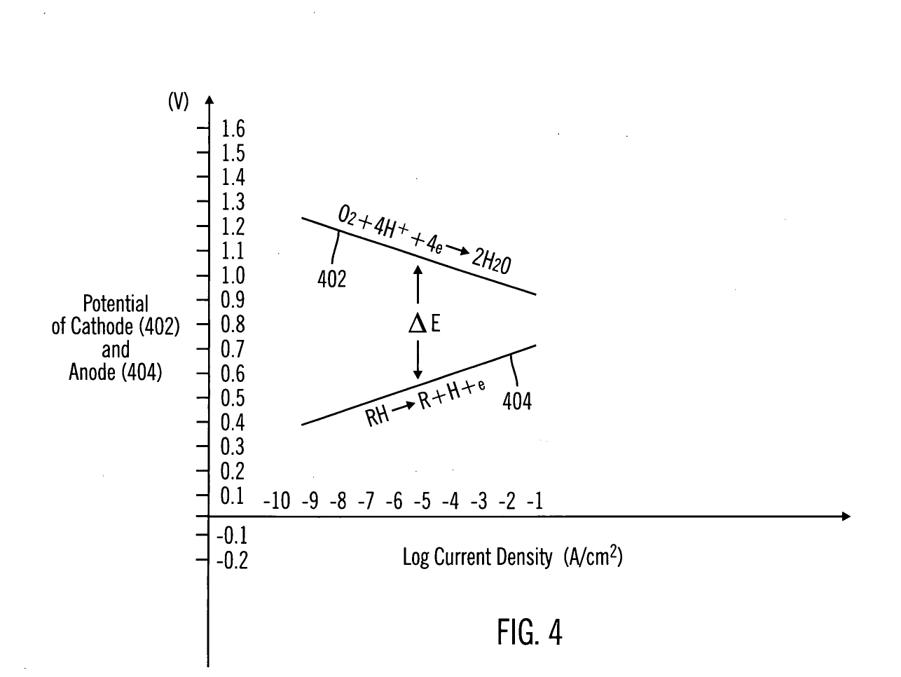

FIG. 3 shows a magnified view of a pore 202 in the cathode 110, according to one embodiment. In this view, it can be seen that the pore 202 is defined by the platinum material 302 which resides as catalyst within the pores of the cathode 110. The cathode itself may be made of a variety of materials, e.g., graphite, titanium dioxide, titanium, and others. On these materials is placed minutely sized catalyst particles, e.g., platinum, lead dioxide, and others. In the pore 202, the solution 114 outside the cathode 110 comes into contact with the air 132 inside the cathode 110. A three-phase boundary exists at the meeting point between the air 132 and the solution 114—the phases being the gas (air) 132, the liquid 114, and the solid 302. The small thicknesses of the layers in the three-phase boundary greatly increases the local current densities in these electrodes, thus giving rise to a relatively high current density as measured per external surface area of the cathode. The physics of the three-phase boundary are explained in J. O'M. Bockris and Amuaya Reddy, Modern Electrochemistry, 2^{nd} Ed., vol. 2B, which is herein incorporated by reference in its entirety. The actual meeting of oxygen from the air 132 and the solution 114 results in the oxygen being reduced to water (H₂O).

In one embodiment, the anode 112 is a planar electrode with a stainless steel base or nickel base and covered with a thin layer of ruthenium oxide, which acts as a catalyst for the oxidation of wastes. In other embodiments, other catalyst types are used. In these embodiments, the base continues to be made of stainless steel, but the catalysts are especially designed for the wastes concerned. Examples of catalyst materials are, but not limited to, lead oxide, lead oxide covering titanium, ferric oxide covering titanium, chromium oxide covering titanium, and ruthenium oxide covering titanium.

In addition, carbon-filled polymers may be of help and among these, porous carbon and poly-p-phenylene may be considered as preferred anode materials. The precise nature of the catalyst will vary with the wastes concerned and can be determined empirically.

The anode 112 is in physical contact with the solution 114 and waste material 116. The resulting waste oxidation equations are complex and involve more than a dozen electron transfer reactions in one sequence. This is mainly due to the fact that the waste material 114 consists of a mixture of many different kinds of substances. Therefore, a waste molecule will be represented generically as “RH.” The R represents a complex organic substance, of which many different kinds occur in the wastes. The H represents a hydrogen atom. In the oxidation process, the complex RH substance (which in reality is many different substances depending on the constitution of the wastes) undergoes a process in which it gives an electron to the electrode and, for charge balancing, produces a corresponding H⁺. An exemplary anodic reaction equation is as follows.
RH→R+H⁺+e

In practice, there will be many such processes in one act of the overall reaction. The total number of electrons involved may be as many as 12 or more, but the reactions take place simultaneously and consecutively on the electrode surface and cannot be, in any simple way, described, because the organic compounds of which the waste is made are generally not known in advance.

The electrochemical reactions do not take place in a homogeneous sense in solutions, but take place at the surface of the electrodes. In a sense, therefore, it can be said that the two reactants of an electrochemical reaction never meet each other in the physical sense of contacting as is necessary in a chemical reaction. The electrodes are the vehicles that facilitate the transfer of electrons.

Referring again to FIG. 1, it can be seen that the anode 112 and cathode 110 are electrically connected via a resistive load 124. The load 124 represents any load driven by the apparatus, such as an electric motor, light, electronic device, or the like. Electrons produced by the anodic reaction in which the wastes are oxidized run through and drive the resistive load 124.

One embodiment of the present invention works with a solution 114 of concentrated sulfuric acid (H₂SO₄) heated to a temperature of about 90° C. The current produced depends upon the catalyst used on the electrodes but is measured in units of mA/cm², with a cell potential in the region of half a volt.

In another embodiment, the solution 114 is very concentrated H₃PO₄ (about 2 percent water) and this material is heated to a temperature of about 130-140° C. The result of the added temperature is to increase the current rate, which may reach about 10 mA/cm², with a cell potential of as much as 0.5 volts.

As a result of the electrochemical reactions, available at the cathode 110 is oxygen and a net negative charge. The cathodic reaction can be characterized as:
O₂+4H⁺+4e→2H₂O

Thus, a net flow of electrons, i.e., electrical power, travels through and drives the load 124.

The nature of the anodic reaction which converts the waste is complex and occurs in a number of consecutive and simultaneous steps. The following is an exemplary step-by-step procedure, which will be different for each component for the many components of wastes. In the following, an example is given for the relatively simple organic substance methanol. Here, the mechanism of the reaction is as follows.
CH₃OH [symbol] CO+4H⁺+4e
H₂O [symbol] OH+H⁺+e
CO+OH→COOH
COOH [symbol] CO₂+H⁺+e

Thus, the example given, of the oxidation of an organic compound, is a six electron transfer reaction. As already stated, the reactions in the conversion of waste products may be much longer because many organic molecules in the waste product are typically considerably more complex than methanol (CH₃OH). Other examples of more complex organic reactions are provided in Surface Electrochemistry, Bockris and Kahn, 1992, which is herein incorporated by reference in its entirety.

In this embodiment, some of the byproducts of the process (e.g., nitrogen, water vapor, and others) exit the chamber 106 through the upper portion of the chamber 106 and are allowed to escape into the atmosphere or collected for other purposes. The CO₂, however, is not allowed to enter the atmosphere and, instead, is sequestered. For sequestration, the chambers can be sealed so that the byproducts exit at a single port and the gaseous byproducts are prevented from entering the atmosphere.

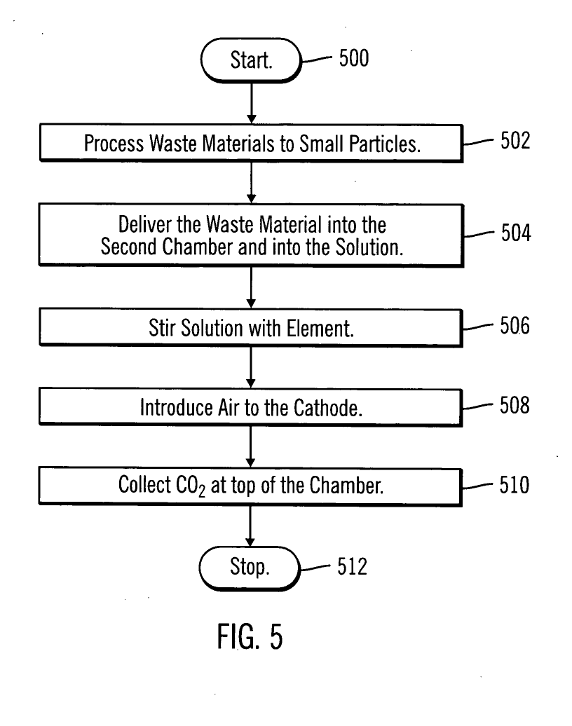

Referring now to FIG. 4, there is shown a graph of the resultant potentials versus the log of current density in the both the cathode 110 and anode 112 in the waste-reducing process described above. In the graph of FIG. 4, the Y-axis shows voltages. The X-axis shows log current densities, or the logarithmic rate of waste conversion. The upper line 402 represents the reduction of O₂ at the cathode 110. The lower line 404 represents the conversion of the wastes at the anode 112. The distance between the lines 402 and 404, as measured along the Y-axis, gives the potential difference between the cathode 110 and anode 112 as the waste-reduction process occurs.

In one embodiment of the present invention, to ensure that the solution 114 and waste 116 make contact with the anode 112, an element 128, such as a blade or other moving object, is provided within at least the second chamber 106. As the element 128 spins, the solution 114 is moved within the second chamber 106, along with the waste material 116, creating a homogenous blend of the solution 114 and waste 116.

In this embodiment of the present invention, the chamber 106 is made of glass or other non-magnetic materials and the element 128 is driven by magnetic induction from a motor located on the outside of the chamber 106. In another embodiment, the element 128 is driven by a shaft 130 attached to a motor located outside the chamber. The element 128 can be replaced with two or more elements that move in the same direction or in different directions. Other devices or methods for stirring, shaking, or mixing the solution can be used in further embodiments without departing from the spirit and scope of the present invention.

It is important to realize that IR losses in the circuit will reduce the total power available at the resistive load 124. IR losses occur as ions pass through the solution 114 between the cathode 110 and anode 112. It is therefore advantageous to provide the cathode 110 and anode 112 in as close proximity to each other as is effectively possible. In one embodiment of the present invention, a single chamber configuration is utilized to bring the cathode 110 and anode 112 together. The single chamber configuration is shown in FIG. 6, where the cathode 110 and anode 112 are submerged in a quantity of solution 114. In this configuration, all of the components shown in FIG. 1 are provided within the single chamber 600. The minimum distance between the cathode 110 and anode 112 is limited, however. If a large amount of the waste material 116 intended to be available at the anode 112 is in contact with the cathode 110, the oxygen reaction at the cathode 110 may be impeded.

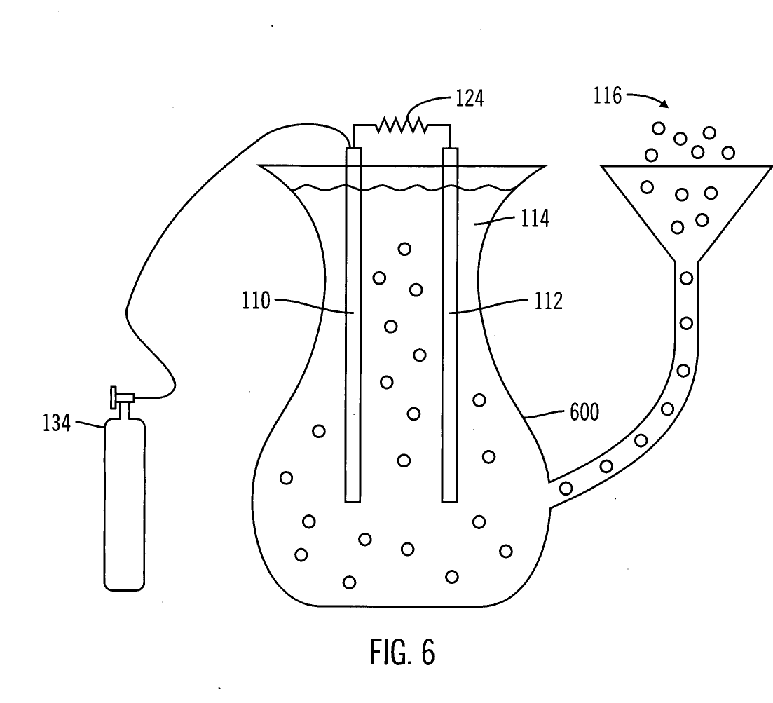

Referring now to FIG. 5, a flow chart of the process for converting waste materials according to a preferred embodiment of the present invention is shown. The process begins at step 500 and moves directly to step 502, where the waste materials 116 are treated through a series of actions which result in it being converted to very tiny particles. Next, in step 504, the wastes 116, in powdered form, are added to one of the two chambers, which contains a solution 114, preferably sulfuric acid (H₂SO₄) or very concentrated phosphoric acid (H₃PO₄). Having added the wastes 116, the solution 114 is stirred, in step 506, until a maximum amount has been dissolved. In step 508, air 132 is introduced, at a slight external pressure, to the porous oxygen cathode 110. The air 132 causes the reaction to begin, so that wastes 116 are oxidized at the anode 112 and the oxygen in the air 132 is reduced at the cathode 110. The final product is largely CO₂ with some nitrogen. Finally, in step 510, the evolved CO₂ is sequestered. A batch type process is envisioned here. However, other embodiments of the present invention include a continuous process of waste conversion that is achieved by a gradual introduction of more of the highly powdered wastes 116 into the mixture 114 or a series of material introductions into the solution 114. In the continuous embodiments, one or more of the illustrated steps occur simultaneously and or continuously.

In the case of sewage disposal, it is advantageous to mix the solid and the liquid components. The advantage comes from the fact that the liquid component (urine) contains sodium chloride. Chlorine is therefore evolved at the anode along with the production of CO₂. However, the evolution of chlorine is relatively minor and the chlorine does not escape into the atmosphere. Instead, it reacts with the surrounding aqueous solution to form hypochlorous acid, HOCL. This material is a bleaching agent and bleaches the solution so that the final result, after a period of time, is a clear solution containing mainly a residue of sodium chloride. The sodium chloride can be removed and, because it is harmless to the environment, simply returned to a waste water supply arrangement. The equation for chlorine evolution is as follows.
2Cl⁻→Cl₂+2e

As described above, embodiments of the present invention allow waste, whether municipal wastes, garden and farm wastes, or sewage, to be disposed of efficiently by converting the waste to gaseous byproducts. Because the process is a fuel cell process, it produces electricity and does not need to be driven. The process relieves current concerns with waste storage. Additionally, large areas of land dedicated to the storage of solid waste can be freed for more useful purposes. Furthermore, the present invention reduces concerns regarding pollution and water contamination.

The processes so far described are effective for converting the majority of waste types. However, it is foreseeable that waste materials may be encountered that do not oxidize as easily as do others. These less-frequently encountered waste types require high temperatures for chemical oxidation in solution, e.g., temperatures in excess of 1000° C.

In one embodiment of the present invention, an electric potential generated by an outside source is applied between the anode 112 and cathode 110. For example, the resistive load 124, shown in FIG. 1, can be replaced by a battery. The applied potential is low and is in the range of about 0.2-0.3 V. The applied potential is effective in causing the oxidation of those wastes that are not converted by the reaction electrochemical process previously described herein.

It is envisaged that the fuel cell of the present invention could be used in household waste disposal so as to eliminate or reduce the need for drains and sewage systems. In a further development of the system, the electricity produced by the fuel cell conversion of the wastes can be “exported” from each house and added together. Each house or other building, therefore, becomes an electricity generating station in a lager circuit, thereby contributing a significant positive economic impact.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

What is claimed is:

1. An apparatus for converting waste material, the apparatus comprising:
a container;
a solution provided within the container;
an opening in the container for receiving waste material into the solution;
an oxygen supply supplying oxygen molecules;
a cathode disposed in the container and at least partially submerged in the solution, the cathode reducing the oxygen molecules and donating electrons to oxygen molecules in the solution, adsorbed on the electrode;
an anode disposed in the container and at least partially submerged in the solution, the anode receiving electrons from the waste material in the solution; and
an electrically conductive path electrically coupling the cathode and the anode, the electrons moving via the electrically conductive path from the anode to the cathode so as to produce an electric current.

2. The apparatus according to claim 1, further comprising:
a resistive load disposed along the conductive path between the cathode and the anode.

3. The apparatus according to claim 1, wherein the container comprises:
a first chamber in which the cathode is disposed; and
a second chamber in which the anode is disposed, the second chamber being in liquid communication with the first chamber.

4. The apparatus according to claim 3, further comprising a proton-conducting membrane disposed between the first chamber and the second chamber.

5. The apparatus according to claim 1, wherein the solution comprises at least one of sulfuric acid and phosphoric acid.

6. The apparatus according to claim 1, further comprising at least one heating element for heating the solution.

7. The apparatus according to claim 1, further comprising:
an element within the container for stirring or mixing the solution and the waste material.

8. The apparatus according to claim 1, wherein the anode comprises:
ruthenium oxide.

9. The apparatus according to claim 8, wherein the anode further comprises carbon supporting the ruthenium oxide.

10. The apparatus according to claim 1, wherein the cathode comprises at least one of platinum and a platinum containing compound.

11. The apparatus according to claim 11, wherein the platinum of the cathode is porous.

12. The apparatus according to claim 1, further comprising:
a catalyst material disposed on the anode.

13. The apparatus according to claim 12, wherein the catalyst comprises at least one of lead oxide covering titanium, ferric oxide, chromium oxide covering titanium, and ruthenium oxide covering titanium.

14. A method for converting waste material, the method comprising the steps of:
adding waste material to a chamber that includes a highly acidic solution, a cathode that includes a metallic catalyst, and an anode that includes a catalyst, the cathode and anode being coupled by an electrically conductive path;
supplying oxygen so that the cathode reduces oxygen molecules by donating electrons, the electrons partaking in the oxidation and conversion of the waste material; and
receiving with the anode, electrons from the waste material,
wherein the electrons move from the anode to the cathode through the electrically conductive path so as to produce an electric current.

15. The method according to claim 14, further comprising the step of:
heating the solution.

16. The method according to claim 14, wherein the solution comprises at least one of sulfuric acid and phosphoric acid.

17. The method according to claim 14, further comprising the step of:
sequestering at least one gaseous byproduct.

18. The method according to claim 14, further comprising the step of:
processing the waste material to small pieces prior to adding the wastes material to the container by performing at least one of chopping, grinding, tearing, and sonic vibration.

18. The method according to claim 14, further comprising the step of:
stirring the solution and the waste material.

20. The method according to claim 14, further comprising the step of:
driving a load provided in a conductive path between the anode and the cathode.
